(19) United States
(12) Patent Application Publication
(10) Pub. No.: US 2009/0253066 A1
(43) Pub. Date: Oct. 8, 2009

(54) Wet developer

(75) Inventor: Chiaki Yamada, Ibaraki-shi (JP)

Correspondence Address: BRINKS HOFER GILSON & LIONE, P.O. BOX 10395, CHICAGO, IL, 60610, US

(73) Assignee: Konica Minolta Business Technologies, Inc.

(21) Appl. No.: 12/384,275

(22) Filed: Apr. 2, 2009

(30) Foreign Application Priority Data
Apr. 2, 2008 (JP) 2008-095930

(51) Int. Cl. G03G 9/12; G03G 9/087

(52) U.S. Cl. 430/109.4

(57) ABSTRACT

A wet developer in which toner particles containing at least a colorant and a binder resin are dispersed in a non-volatile carrier solution by using a dispersant. By using as the binder resin a polyester resin having a weight-average molecular weight Mw in a range of 20,000≦Mw≦350,000, it becomes possible to improve storage stability without degradation of fixing property.

This application is based on application(s) No. 2008-095930 filed in Japan, the contents of which are hereby incorporated by reference.

### BACKGROUND OF THE INVENTION

1. Technical Field

The present invention relates to a wet developer for use in an image-forming apparatus using a wet electrophotographic system, such as a copying machine, a printer and a digital printing machine.

2. Background Art

In an image-forming process of the electrophotographic system, in general, an electrostatic latent image is formed on an electrostatic latent-image supporting member such as a photosensitive member, for example, by exposing an image in association with a document image or image data thereto, and by developing this electrostatic latent image, a visible toner image is formed, and the toner image is transferred and fixed onto an image-recording medium so that a target image is obtained.

The developing system can be classified into a dry developing method and a wet developing method. In the dry developing method, a toner or a toner to which a carrier having a magnetic property or the like is added is used as the developer. In general, a toner, mainly composed of a pigment and a binder resin, to which a charge control agent, a conductivity control agent, a plasticizer, a release agent and the like are externally or internally added, if necessary, is used as a dry toner. On the other hand, in the wet developing method, a wet developer, prepared by dispersing toner particles mainly composed of a pigment and a binder resin, a charge control agent, a dispersion stabilizer and the like in a dispersion medium (carrier solution) having an electric insulating property, is used. The toner particles to be used in the wet developer can be formed into fine particles because there is no fear that the particles might be scattered and released into the air, and those having an average particle size of sub-micron can be put into practical use. For this reason, the resulting advantages are that an image having high resolution can be obtained, superior gradation can be achieved, and the like. For example, Japanese Patent Application Laid-Open No. 10-282733 describes a wet developer containing a polyester resin as the binder resin, colorant fine particles having a volume-average particle size in a range from 1.5 to 5.0 μm and an electrically insulating solvent in which the colorant fine particles are dispersed.

### SUMMARY OF THE INVENTION

Technical Problem

However, the wet developer has a problem in that storage stability is not desirably maintained for a long period of time. That is, the wet developer is stored in a developing vessel in an image-forming apparatus for several days to several months, and since the dispersed state of the toner particles changes with time due to aggregation or the like, there is a problem that the image density, resolution and fixing property tend to deteriorate.

Therefore, an object of the present invention is to provide a wet developer superior in storage stability, and consequently to solve the above-mentioned problems.

Solution to Problem

The technical problem can be solved by a wet developer,

wherein toner particles containing at least a colorant and a binder resin are dispersed in a non-volatile carrier solution by using a dispersant, wherein the binder resin is a polyester resin having a weight-average molecular weight Mw in a range from 20,000=Mw=350,000.

### ADVANTAGEOUS EFFECTS OF INVENTION

In accordance with the present invention, by using a polyester resin having a weight-average molecular weight Mw in a range from 20,000=Mw=350,000 as a binder resin of toner particles, it is possible to provide a wet developer which can achieve both of fixing property and storage stability over a long period of time.

### BRIEF DESCRIPTION OF THE DRAWINGS

FIG. 1 is a schematic drawing showing one example of a structure of a wet image-forming apparatus.

FIG. 2 is a graph showing a relationship between Mw of a polyester resin and a particle-size ratio of toner particles.

### DESCRIPTION OF EMBODIMENTS

In general, a binder resin to be often used as a dry toner for the dry developing method is a polyester resin having a weight-average molecular weight Mw of about or less. This is because, in the case of the dry toner, a polyester resin having a high molecular weight requires a large amount of energy upon carrying out a fixing process, and therefore it is not preferable. On the other hand, even in toner particles for use in the conventional wet developing method, a polyester resin having a weight-average molecular weight Mw of about 10,000 or less is used. For example, in the aforementioned Japanese Patent Application Laid-Open No. 10-282733, a polyester resin having a weight-average molecular weight in a range from 2000 to 10000 is used. In contrast, the present inventors have found that, in the wet developing method, even a polyester resin having a weight-average molecular weight of 20000 or more can achieve both of fixing property and storage stability over a long period of time, and these findings have now led to completion of the present invention. That is, the wet developer of the present invention is provided with toner particles containing at least a colorant and a binder resin, which are dispersed in a non-volatile carrier solution by using a dispersant, wherein the binder resin is a polyester resin having a weight-average molecular weight Mw in a range from 20,000≦Mw≦350,000.

In the present invention, it is preferable that the dispersant is a polymer dispersant containing a basic group.

The basic group is preferably a pyrrolidone group.

The polyester resin preferably has a glass transition temperature (Tg) in a range from 65 to 85° C.

It is preferable that the polyester resin is contained in the toner particles at a content of 50% by weight or more.

The following description explains embodiments of a wet developer of the present invention in detail.

The wet developer of the present invention relates to a wet developer in which toner particles contain at least a colorant and a binder resin and are dispersed in a non-volatile carrier solution by using a dispersant, and the binder resin is a polyester resin having a weight-average molecular weight Mw in a range of 20,000≦Mw≦350,000.

The wet developer of the present invention contains at least a carrier solution, toner particles and a dispersant.

(Toner Particles)

The toner particles to be used in the present invention contain at least a colorant and a binder resin. A thermoplastic polyester resin is used as the binder resin. The reason that the polyester resin is used is not only because physical properties such as thermal characteristics of the toner particles can be changed in a wide range, but also because beautiful colors are obtained since a superior light-transmitting property is obtained upon forming a color image and because a tough resin film is prepared after a fixing process since superior spreadability and viscoelasticity are obtained so that a good adhesive property to a recording medium such as a paper is available. The content of the polyester resin in the toner particles is set to 50% by weight or more, preferably 80 to 95% by weight.

The weight-average molecular weight (Mw) of the polyester resin is desirably set in a range from 20,000 or more to 350,0000 or less, preferably 200,000 or less. In the case of Mw less than 20,000, the long-term storage property deteriorates, and therefore it is not preferable. In the case of Mw higher than 200,000, the gloss of a fixed image is lowered.

The glass transition temperature (Tg) of the polyester resin is preferably set in a range from 65 to 85° C. In the case of Tg lower than 65° C., the storage stability deteriorates, while in the case of Tg higher than 85° C., the heat quantity required for fixing increases extremely, and at the same time, the gloss of a fixed image is lowered, and therefore it is not preferable.

The polyester resin refers to a thermoplastic resin obtained by polycondensation between polyvalent alcohol and polybasic acid (polycarboxylic acid).

Examples of the polyvalent alcohol include, but are not particularly limited to, alkylene glycols (aliphatic glycol) including ethylene glycol, diethylene glycol, triethylene glycol, propylene glycols such as 1,2-propylene glycol, dipropylene glycol, butane diols such as 1,4-butane diol, neopentyl glycol, hexane diols such as 1,6-hexane diol, and alkylene oxide adducts thereof; phenol-type glycols including bisphenols, such as bisphenol A and hydrogenated bisphenol, and alkylene oxide adducts thereof; alicyclic and aromatic diols, such as monocyclic or polycyclic diol; and triols, such as glycerin and trimethylolpropane. The polyester resin is formed by mixing one kind or two kinds or more of them. In particular, 2 to 3 mole alkylene oxide adducts of bisphenol A are preferably used. It is because it becomes possible to provide the resulting polyester resin with solubility, stability and low costs. Examples of the alkylene oxides include ethylene oxides and propylene oxides.

Examples of the polybasic acid (polycarboxylic acid) include, but are not particularly limited to, saturated or unsaturated dibasic acids, such as malonic acid, succinic acid, adipic acid, azelaic acid, sebacic acid, fumaric acid, maleic acid, itaconic acid, phthalic acid and its modified acid (for example, hexahydrophthalic anhydride), isophthalic acid and terephthalic acid; trifunctional or more saturated polybasic acids, such as trimellitic acid, trimesic acid, pyromellitic acid and methylnadic acid; and acid anhydrides and lower alkyl esters thereof. These may be used alone, or two or more kinds of these may be used in a mixed manner. In particular, from the viewpoints of solubility and stability of the resulting polyester resins, isophthalic acid and terephthalic acid are suitable for a toner binder resin for a wet developer, and also preferable because of low costs.

By subjecting the above-mentioned polybasic acids and polyvalent alcohol to a polycondensation process so that a desired polyester resin can be obtained. Any of conventionally known polycondensation methods may be used as the polycondensation method. The process is generally carried out at a temperature of about 150° C. to 300° C. although it depends on the kind of a material monomer.

The process may be carried out under arbitrary conditions, such as under an inert gas atmosphere as an ambient gas, by using various kinds of solvents, or by keeping the pressure of the reaction container at normal pressure or at a reduced pressure. An esterifying catalyst may be used for accelerating the reaction. As the esterifying catalyst, metal organic compounds, such as tetrabutyl zirconate, zirconium naphthenate, tetrabutyl titanate, tetraoctyl titanate and 3/1 stannous oxalate/sodium acetate, or the like may be used; however, those in which the resulting product, ester, is not colored are preferably used. Alkyl phosphate, allyl phosphate or the like may be used as a catalyst or a hue-adjusting agent.

The reaction time may be adjusted in general in order to adjust the molecular weight of the polyester resin as the resulting product. Since the polycondensation reaction for polyester is a sequential reaction in which a low molecular substance is gradually increasing its molecular weight, the molecular weight increases with time. The relationship between the reaction time and the molecular weight differs depending on the kinds of a monomer material, polymerization conditions, a lot scale and the like, and, for example, in the case of polyesterification reaction between hexane diol and sebacic acid, after the reaction for 1 to 2 hours under a nitrogen gas flow at a temperature of 200° C., a product having a molecular weight of about 10000 is obtained, after the reaction of 4 to 5 hours under the same conditions, a product having a molecular weight of about 200,000 is obtained, and after the reaction of 7 to 8 hours under the same conditions, a product having a molecular weight of about 300,000 is obtained. In an attempt to obtain a resin having a high molecular weight, by setting the mixing molar ratios between polyvalent alcohol and polybasic acid to virtually the same value, it becomes possible to increase the degree of polymerization. By prolonging the reaction time with the reaction temperature being made slightly lower, a product having a high molecular weight can be obtained more efficiently.

(Dispersant)

In order to disperse toner particles in a carrier solution, a dispersant may be used. Example of the dispersant to be used include, but are not particularly limited to, a dispersant that is adsorbed on the toner particles and dissolved or semi-dissolved in the carrier solution to exhibit a neutral property, a polymer dispersant having a basic group or the like, and a polymer dispersant having a basic group is preferably used. It is because by using the polymer dispersant having a basic group, it is possible to further improve the storage stability. Examples of the basic group include an aromatic amino group, an aliphatic amino group, a heterocyclic nitrogen-containing group, a heterocyclic oxygen-containing group and a heterocyclic sulfur-containing group. More specifically, a polymer dispersant having at least one kind of basic groups selected from the group consisting of an amide group, a methylol group, a pyridine group, a pyrrolidone group, an imidazole group, an imine group and amino group may be used. Preferably, the pyrrolidone group is used.

Examples of the polymer dispersant having a pyrrolidone group include a homopolymer of N-vinyl-2-pyrrolidone and a copolymer thereof. Examples of the copolymer include a random copolymer or a graft copolymer between N-vinyl-2-pyrrolidone and a methacrylic acid ester. Examples of the copolymerizable monomer include not only a methacrylic acid ester, but also an acrylic acid ester and an alkylene compound. A carbon number of the alkyl group in the methacrylic acid ester and the acrylic acid ester is preferably set to 10 to 20. A carbon number of the alkyl group in the alkylene compound is preferably set to 10 to 30.

Commercially available products may be used as the polymer dispersant having a pyrrolidone group. Examples thereof include “Antaron® V-216” and “Antaron® V-220” (both made by GAF/ISP Chemicals Co., Ltd.).

Preferably, 0.5 to 100 parts by weight of the above-mentioned dispersant is added to 100 parts by weight of toner particles. It is because the amount of the dispersant less than 0.5 parts by weight causes degradation of the dispersibility, and the amount thereof more than 100 parts by weight makes the conductivity of the developer higher, resulting in problems with the charging property.

(Carrier Solution)

It is necessary that a solvent to be used as the carrier solution have a resistance value (about 10¹¹ to 10¹⁶ Ω·cm) in such a degree as not to disturb an electrostatic latent image. Furthermore, the solvent preferably has neither offensive odor nor toxicity. In general, examples thereof include aliphatic hydrocarbons, alicyclic hydrocarbons, aromatic hydrocarbons, halogenated hydrocarbons and polysiloxane. In particular, from the viewpoints of odor, non-toxicity and low costs, a normal paraffinic solvent and an isoparaffinic solvent are preferably used. Specific examples thereof include such as Moresco White® (made by Matsumura Oil Research Corp.), Isopar® (made by Exxon Chemical Ltd.), Shellsol 71 (made by Shell Chemicals Japan Ltd.), and IP Solvent® 1620 and IP Solvent® 2028 (both made by Idemitsu Kosan Co., Ltd.). In the present invention, the non-volatile solvent refers to a solvent having a flash point of 70° C. or more, unless otherwise indicated.

(Colorant)

Any of conventionally known pigments and dyes may be used as the colorant. For example, the following pigments may be used. Carbon black may be used as a black colorant. Yellow pigments, magenta pigments and cyan pigments are exemplified as colorants for colors other than black. A color-image forming process is carried out through subtractive mixture based upon these pigment colors. Examples of the cyan pigment include copper phthalocyanine blue-based pigments, such as C.I. Pigment Blue 15:1 and 15:3. Examples of the magenta pigment include azolake-based magenta pigments and insoluble azo-based magenta pigments, such as C.I. Pigment Red 48, 57 (Carmine 6B), 5, 23, 60, 114, 146 and 186, thioindigo-based magenta pigments, quinaquridon-based magenta pigments, such as C.I. Pigment Red 122, 209 and C.I. Pigment Violet 19, and naphthol-based magenta pigments, such as C.I. Pigment Red 269. Examples of the yellow pigment include cis-azo-based yellow pigments typically represented by Color Index (C.I.) Pigment Yellow 12, 13, 14, 17, 55, 74, 81, 83 and 185.

The addition amount of the colorant to the binder resin is set to 5 to 30 parts by weight, preferably 10 to 20 parts by weight, relative to 100 parts by weight of the resin.

(Production of Developer)

A colored kneaded matter composed of the above-mentioned binder resin, colorant and the like, is coarsely pulverized by using a cutter mill, a jet mill or the like so that a coarsely pulverized toner in which the colorant having its secondary particle size in a range from 50 nm to 1 μm, preferably from 50 nm to 300 nm, is dispersed is obtained. This coarsely pulverized toner is further subjected to a wet pulverizing process in a carrier solution containing a dispersant so that the toner particles are finely pulverized so as to have a volume-average particle size in a range from 0.1 to 10 μm, preferably from 0.5 to 5 μm; thus, a thick wet developer is obtained. The thick wet developer thus obtained is further subjected to diluting and dispersing processes by using a carrier solution containing additives, such as a charge-control agent, if necessary, so as to have an appropriate concentration so that a wet developer is obtained.

### EXAMPLES

The present invention will be described more detail by way of the following examples; however, the present invention is not intended to be limited thereto. In the following examples, the term “parts” refers to “parts by weight”, the term “Mw” refers to “weight-average molecular weight”, the term “Mn” refers to “number-average molecular weight” and the term “Tg” refers to “glass transition temperature”, unless otherwise indicated.

(Synthesis Example of Polyester Resin)

Into a four-neck flask equipped with a stirring bar, a partial condenser, a nitrogen-gas introducing pipe and a thermometer, 700 parts of propylene oxide adducts of bisphenol A (polyvalent alcohol) and 300 parts of terephthalic acid (polybasic acid) were charged as monomers, and to this was introduced a nitrogen gas, while being stirred, so that a polycondensating process was carried out at a temperature of about 180° C. At the time when Mw reached about 310,000, the temperature was lowered to about 100° C., and to this was added 0.01 parts of hydroquinone as a polymerization inhibitor to stop the polycondensation. The resulting product thus obtained was used as polyester resin 1. After the completion of the polycondensation, Mw of the resulting polyester resin 1 was measured, and it was 330,000.

Polyester resins 2 to 8 were synthesized by using the same method as the above-mentioned method except that the loaded composition and reaction time were changed. The loaded composition of each of the synthesized polyester resins 1 to 8, Mw and Tg of each of the resulting polyester resins are shown in Table 1.

TABLE 1

| | | | | Physical | |
|---|---|---|---|---|---|
| | | | | property | |
| | Composition | | Mw prior | values | |
| | Polyvalent alcohol | Polybasic acid | to reaction stop | Mw | Tg |
| Polyester | Bisphenol | Terephthalic | 310000 | 330000 | 89.5° C. |
| resin 1 | A-propyleneoxide | acid/300 parts | | | |
| | adduct/700 parts | | | | |
| Polyester | Bisphenol | Isophthalic | 240000 | 260000 | 84.5° C. |
| resin 2 | A-ethyleneoxide | acid/300 parts | | | |
| | adduct/600 parts | | | | |
| Polyester | Bisphenol | Terephthalic | 100000 | 130000 | 87.6° C. |
| resin 3 | A-ethyleneoxide | acid/300 parts | | | |
| | adduct/700 parts | | | | |
| Polyester | Bisphenol | Isophthalic | 52000 | 54000 | 80.3° C. |
| resin 4 | A-propyleneoxide | acid/220 parts | | | |
| | adduct/500 parts | | | | |
| Polyester | Bisphenol | Terephthalic | 20000 | 22300 | 79.5° C. |
| resin 5 | A-propyleneoxide | acid/250 parts | | | |
| | adduct/500 parts | | | | |
| Polyester | Bisphenol | Isophthalic | 18000 | 20400 | 65.7° C. |
| resin 6 | A-propyleneoxide | acid/220 parts | | | |
| | adduct/500 parts | | | | |
| Polyester | Bisphenol | Isophthalic | 16000 | 17900 | 62.8° C. |
| resin 7 | A-propyleneoxide | acid/220 parts | | | |
| | adduct/500 parts | | | | |
| Polyester | Bisphenol | Isophthalic | 6000 | 6200 | 56.7° C. |
| resin 8 | A-propyleneoxide | acid/220 parts | | | |
| | adduct/500 parts | | | | |

(Production Example of Toner Particles)

After 100 parts of polyester resin 1 and 10 parts of carbon black “Mogul-L” (made by Cabot Corporation) had been sufficiently mixed by a Henschel mixer, the mixed matter was melt and kneaded at a heating temperature of 100° C. in the roll, by using a homodirectional rotation twin-screw extruder, and the resulting mixture was cooled and coarsely pulverized so that a coarsely pulverized toner A was obtained.

By using polyester resins 2 to 8, coarsely pulverized toners B to H were obtained by the same method as described above.

(Synthesis Example of Polymer Dispersant)

An N-vinyl pyrrolidone/lauryl methacrylate copolymer was synthesized by using a method disclosed in JP-A No. 8-220812. That is, Moresco White® P40 (made by Matsumura Oil Research Corporation) (100 parts), lauryl methacrylate (45 parts), N-vinyl-2-pyrrolidone serving as a basic monomer (3 parts) and azobisisobutyronitrile (0.2 parts) serving as a polymerization initiator were reacted in a nitrogen atmosphere at a reaction temperature in a range from 60 to 70° C. for about 12 hours so that an N-vinyl pyrrolidone/lauryl methacrylate copolymer was obtained.

(Production of Wet Developer)

### Example 1

Moresco White® P40 (made by Matsumura Oil Research Corporation) (75 parts), coarsely pulverized toner A (25 parts) and a predetermined amount of a dispersant were mixed, and the mixture was wet-pulverized by using a sand mill. The wet-pulverizing process was stopped at the time when a predetermined toner particle size was attained to obtain a wet developer. Table 2 shows the composition of the wet developer.

### Examples 2 to 8

By using coarsely pulverized toners B to F and dispersants shown in Table 2, wet developers were obtained by the same method as in Example 1. The composition of each wet developer is shown in Table 2.

### Comparative Examples 1 and 2

By using coarsely pulverized toners G and H and dispersants shown in Table 2, wet developers were obtained by the same method as in Example 1. The composition of each wet developer is shown in Table 2.

TABLE 2

| | Developer composition | | | | Evaluation items | | | |
|---|---|---|---|---|---|---|---|---|
| | | Toner | | | Particle | | | |
| | | average | | Added | size | Storage | Fixing | |
| | Toner (binder resin) | particle size | Dispersant | amount | ratio | stability | property | Gloss |
| Example 1 | Coarsely pulverized | 3.1 μm | N-vinyl pyrrolidone/alkylene | 0.5 parts | 1.01 | ⊙ | ◯ | Δ |
| | toner A (Polyester resin 1) | | copolymer (V216) | | | | | |
| Example 2 | Coarsely pulverized | 3.2 μm | N-vinyl pyrrolidone/alkylene | 0.5 parts | 1.01 | ⊙ | ◯ | Δ |
| | toner B (Polyester resin 2) | | copolymer (V220) | | | | | |
| Example 3 | Coarsely pulverized | 3.1 μm | N-vinyl pyrrolidone/alkylene | 0.5 parts | 1.00 | ⊙ | ◯ | ◯ |
| | toner C (Polyester resin 3) | | copolymer (V220) | | | | | |
| Example 4 | Coarsely pulverized | 3.3 μm | N-vinyl pyrrolidone/alkylene | 0.5 parts | 1.03 | ⊙ | ◯ | ◯ |
| | toner D (Polyester resin 4) | | copolymer (V216) | | | | | |
| Example 5 | Coarsely pulverized | 3.1 μm | N-vinyl pyrrolidone/lauryl | 0.5 parts | 1.08 | ⊙ | ◯ | ◯ |
| | toner E (Polyester resin 5) | | methacrylate copolymer | | | | | |
| Example 6 | Coarsely pulverized | 3.1 μm | N-vinyl pyrrolidone/alkylene | 0.5 parts | 1.13 | ⊙ | ◯ | ◯ |
| | toner F (Polyester resin 6) | | copolymer (V220) | | | | | |
| Example 7 | Coarsely pulverized | 3.1 μm | Polyimine compound | 0.5 parts | 1.11 | ◯ | ◯ | ◯ |
| | toner D (Polyester resin 4) | | (S13940) | | | | | |
| Example 8 | Coarsely pulverized | 3.1 μm | Barium sulfonate | 0.5 parts | 1.15 | ◯ | ◯ | ◯ |
| | toner D (Polyester resin 4) | | | | | | | |
| Comparative | Coarsely pulverized | 3.1 μm | N-vinyl pyrrolidone/alkylene | 0.5 parts | 1.28 | X | ◯ | ◯ |
| Example 1 | toner G (Polyester resin 7) | | copolymer (V220) | | | | | |
| Comparative | Coarsely pulverized | 3.2 μm | N-vinyl pyrrolidone/alkylene | 0.5 parts | 1.42 | X | ◯ | ◯ |
| Example 2 | toner H (Polyester resin 8) | | copolymer (V220) | | | | | |

(Measuring Method of Molecular Weight)

The weight-average molecular weight (Mw) was measured by the gel-permeation chromatography (GPC) method under the following conditions.
Detector: RI
Column: Shodex KF-404HQ+KF-402HQ
Solvent: Tetrahydrofran (THF)
Flow rate: 0.3 ml/min
Calibration curve: Standard polystyrene

(Measurement of Tg)

Tg was measured by using a differential scanning calorimeter DSC-6200 (made by Seiko Instruments Inc.) under conditions of a sample amount of 20 mg and a rate of temperature-rise of 10° C./min.

(Evaluation on Storage Stability)

A developer was put into a sample bottle to about one-half the bottle, and this was stored in a thermostat set at 50° C. for 24 hours. Before and after the storage, the average particle size was measured by using a SALD-2200 (made by Shimadzu Corporation). Those having a particle size ratio (average particle size after the storage/average particle size before the storage) of 1.1 or less were evaluated as “\textcircled{•}”, those having a ratio of 1.2 or less were evaluated as ◯, and those having a ratio exceeding 1.2 were evaluated as “x”. By using the evaluation of storage stability at 50° C. for 24 hours, the same evaluation as that of storage at normal temperature for 6 months can be made in an accelerated manner.

(Fixing Strength Test)

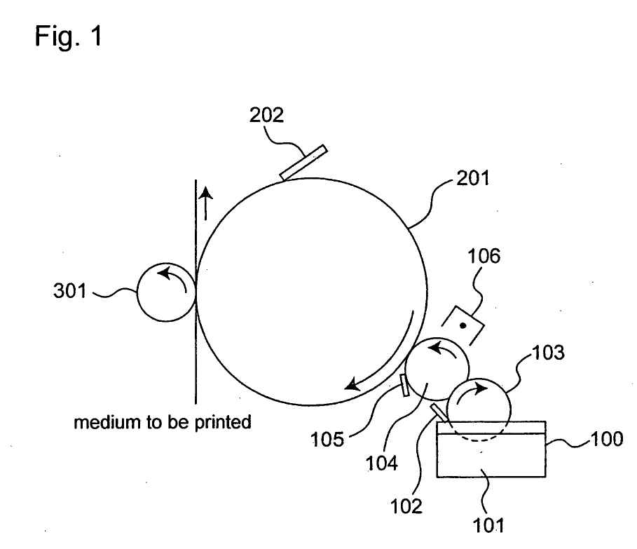

By using the image-forming apparatus of FIG. 1, a solid pattern (10 cm×10 cm, coverage: 2 mg/m²) of each of wet developers of examples and comparative examples was formed on woodfree paper/coat paper. This was then fixed by using a heat roller (180° C.×80 msec of nip time) Thereafter, a portion free from offset was rubbed with a rubber eraser (sand rubber eraser “LION 26111” made by Lion Office Products Corp.) twice under a pressing load of 9.8 N, and the remaining rate of image density was measured by using a “X-Rite Model 404” made by X-Rite, Incorporated and the evaluation of image density was ranked under a three-degree criterion.
◯: Remaining rate of image density was 80% or more.
Δ: Remaining rate of image density was from 70% or more to less than 80%.
×: Remaining rate of image density was less than 70%.

(Gloss Degree Test)

By using the image-forming apparatus of FIG. 1, a solid pattern (10 cm×10 cm, coverage: 2 mg/m²) of each of wet developers of examples and comparative examples was formed on woodfree paper/coat paper. This was then fixed by using a heat roller (180° C.×80 msec of nip time). The degree of gloss was measured by using a gloss meter (VG2000, made by Nippon Denshoku Industries Co., Ltd.). The degree of gloss of each of fixed images was measured, and the degree of gloss was evaluated based upon the following criteria.
◯: Degree of gloss was 30 or more.
Δ: Degree of gloss was from 20 or more to less than 30.
×: Degree of gloss was less than 20.

FIG. 1 is a schematic drawing showing one example of a structure of a test machine for a wet image-forming apparatus. On the periphery of a developing roller 104, a charging device 106, a photosensitive member 201, a cleaning blade 105 and a supply roller 103 are successively disposed in a rotation direction indicated by an arrow, and on the periphery of the photosensitive member 201, a cleaning blade 202 and a transferring roller 301 are disposed.

The surface of the developing roller 104 is uniformly charged to a predetermined surface potential by the charging device 106, and an electrostatic latent image is formed on the surface of the developing roller 104. The supply roller 103 supplies a developing solution 101 onto the developing roller 104 from a developing vessel 100 including the developing solution 101 so that a developing solution coat layer is formed on the surface of the developing roller 104. This developing solution coat layer is maintained at a predetermined thickness by a regulating blade 102. In the case where an anilox roller is used as the supply roller, an engraved pattern of the roller is filled with the developer so that a specific amount thereof is weighed by a regulating roller.

Toner particles are moved through a nip between the developing roller 104 and the photosensitive member 201 so that a toner image is formed on the photosensitive member. This toner image is transferred onto a medium to be recorded by applying a predetermined voltage to the transfer roller 301.

Operation conditions of the image-forming apparatus are shown below:
System velocity: 40 cm/sec
Photosensitive member: negatively chargeable OPC
Charging potential: −700V
Developing voltage (applied voltage to developing roller): −450V
Transferring voltage (applied voltage to transfer roller): +600V
Corona charging prior to developing: applied voltage to needle −3 to 5 kV
Applied voltage to squeeze roller: −500V
Scorotron charging prior to transferring: applied voltage to needle −6 kV, grid −150 to 500V

(Results)

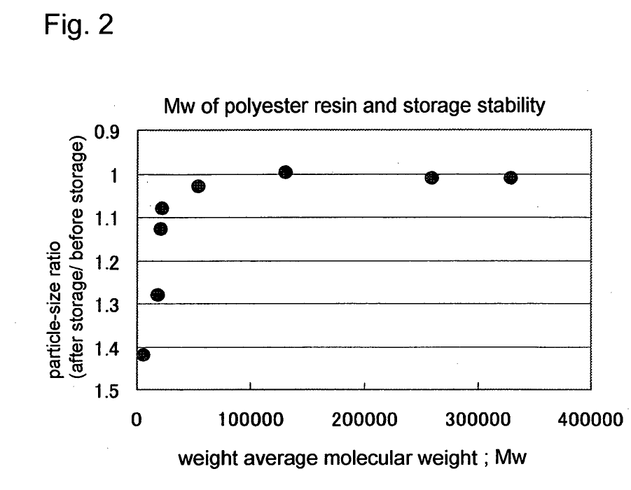

FIG. 2 shows a relationship between Mw of a polyester resin and a particle-size ratio of toner particles. When Mw of a polyester resin became 20000 or more, the particle-size ratio became 1.2 or less so that superior storage stability for a long period of time could be obtained. Table 2 shows the results of evaluation on wet developers of examples and comparative examples. In the case of Mw of 20000 or more, good fixing property and gloss were obtained.

Reference signs List

100: Developing vessel

101: Developing solution

102: Regulating blade

103: Supply roller

104: Developing roller

105: Cleaning blade

106: Charging device

201: Photosensitive member

202: Cleaning blade

301: Transfer roller

What is claimed is:

1. A wet developer,
wherein toner particles containing at least a colorant and a binder resin are dispersed in a non-volatile carrier solution by using a dispersant, wherein the binder resin is a polyester resin having a weight-average molecular weight Mw in a range from 20,000≦Mw≦350,000.

2. The wet developer according to claim 1, wherein the dispersant is a polymer dispersant containing a basic group.

3. The wet developer according to claim 2, wherein the basic group is a pyrrolidone group.

4. The wet developer according to any one of claims 1 to 3, wherein the polyester resin has a glass transition temperature (Tg) in a range from 65 to 85° C.

5. The wet developer according to any one of claims 1 to 4, wherein the polyester resin is contained in the toner particles at a content of 50% by weight or more.
